(19) United States
(12) Patent Application Publication
(10) Pub. No.: US 2018/0365995 A1
(43) Pub. Date: Dec. 20, 2018

(54) AUTOMOBILE COMMUNICATION SYSTEM USING UNMANNED AIR VEHICLE INTERMEDIARY

(71) Applicant: TRW AUTOMOTIVE U.S. LLC, Livonia, MI (US)

(72) Inventor: Brian T. Murray, Novi, MI (US)

(21) Appl. No.: 15/622,193

(22) Filed: Jun. 14, 2017

(51) Int. Cl. G08G 1/0967; G08G 5/00; B64C 39/02

(52) U.S. Cl. CPC G08G 1/096791; G08G 5/0069; B64C 2201/123; G08G 5/0013; B64C 39/022

(57) ABSTRACT

Systems and methods are provided for providing information to a vehicle via an unmanned air vehicle. The unmanned air vehicle includes a detector assembly that converts electromagnetic radiation into an electronic signal and signal processing logic that extracts information representing traffic conditions from the electronic signal. A transceiver communicates with an automobile, such that the extracted information is provided to the automobile

### TECHNICAL FIELD

This invention relates to automobile systems, and more particularly, to a communication system using an unmanned air vehicle intermediary.

### BACKGROUND

Vehicle-to-External (V2X) systems provide additional information to automobiles to augment their situational awareness. Vehicle-to-External systems can include Vehicle-to-Vehicle (V2V) systems, in which vehicles communicate either or both sensed and internally generated information among to proximate vehicles to enhance the available information at each vehicle. Similarly, Vehicle-to-Pedestrian (V2P) systems can inform drivers of the presence of mobile devices on or near their path of travel of the automobile to alert the driver to the presence of pedestrians. Finally, Vehicle-to-Infrastructure systems can inform drivers of road conditions that are not within current view of the vehicle sensors. Accordingly, the safety and convenience of the driver can be enhanced.

### SUMMARY OF THE INVENTION

In accordance with an aspect of the present invention, a communications system comprising an unmanned air vehicle. The unmanned air vehicle includes a detector assembly that converts electromagnetic radiation into an electronic signal and signal processing logic that extracts information representing traffic conditions from the electronic signal. A transceiver communicates with an automobile, such that the extracted information is provided to the automobile.

In accordance with another aspect of the present invention, a method is provided for providing vehicle-to-external services to an automobile. A band of electromagnetic radiation is monitored at an unmanned air vehicle. The monitored electromagnetic radiation is converted into an electronic signal at a detector assembly on the unmanned air vehicle. Information representing traffic conditions is extracted from the electronic signal at signal processing logic. The information representing traffic conditions is communicated to the automobile.

In accordance with yet another aspect of the present invention, a method is provided for providing vehicle-to-external services to an automobile. A location of the automobile is monitored at a unmanned air vehicle. The unmanned air vehicle is moved as to remain within a threshold distance of the monitored location. Information representing traffic conditions is received at the unmanned air vehicle. The received information representing traffic conditions is transmitted to the automobile via a transceiver associated with the unmanned air vehicle.

### BRIEF DESCRIPTION OF THE DRAWINGS

FIG. 1 illustrates a communications system for providing portable infrastructure in a vehicle-to-external communications arrangement;

FIG. 2 illustrates one example of a portable infrastructure system using a plurality of drones in a vehicle-to-external environment;

FIG. 3 illustrates one method for providing vehicle-to-external services to an automobile;

FIG. 4 illustrates another method for providing vehicle-to-external services to an automobile; and

FIG. 5 is a schematic block diagram illustrating an exemplary system of hardware components capable of implementing examples of the systems and methods disclosed in FIGS. 1-4.

### DETAILED DESCRIPTION

Vehicle-to-external data can be used in a number of ways to augment the capabilities of sensors already present on a vehicle, particularly in extending the available data beyond the line-of-sight of the vehicle sensors. This additional information can be applied to a number of safety systems, such as lane keeping and centering, adaptive cruise control, adaptive light control, automated breaking response to object detection, and similar safety systems. Unfortunately, augmenting available infrastructure with sensors and communication units is expensive and labor intensive, and is unlikely to be widely available within the near future. To this end, the inventor has developed systems and methods for deploying portable V2X infrastructure via one or more unmanned air vehicles. For some applications, such a vehicle theft detection, the versatility and mobility of the UAVs can actually provide performance superior to that of fixed infrastructure.

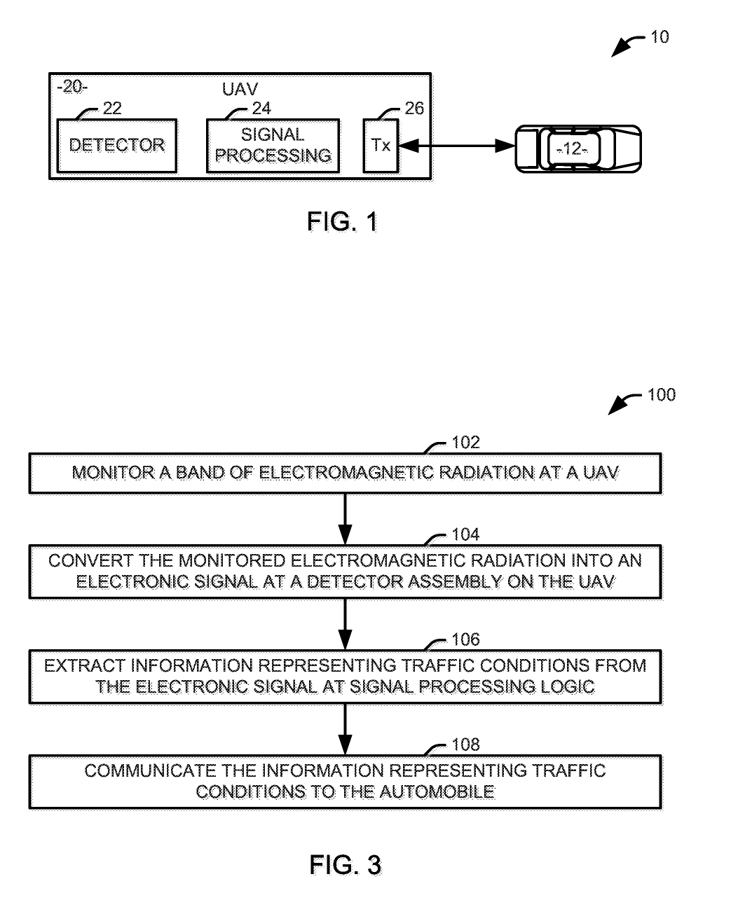

FIG. 1 illustrates a communications system 10 for providing portable infrastructure in a vehicle-to-external communications arrangement. The communications system includes at least an automobile 12 and an unmanned air vehicle 20 (UAV) that communicates with the automobile to provide information representing traffic conditions to the automobile. Traffic conditions, as the phrase is used herein, can include any environmental conditions useful in preserving the safe operation of a vehicle, for example, updates on weather conditions, traffic congestion, and construction along the path of travel of the automobile 12, the positions and trajectories of pedestrians, animals, and other vehicles, a position of the vehicle itself, as well as any other information that might be relevant to a driver. The UAV 20 can include any appropriate air vehicle capable of reaching and maintaining a desired position above the ground, including any of fixed-wing drones, rotorcraft, flapping-wing drones, lighter-than-air platforms, and hybrids of these general types.

The UAV includes a detector assembly 22 that converts electromagnetic radiation into an electronic signal with information representing traffic conditions and signal processing logic 24 that extracts information representing traffic conditions from the electronic signal. It will be appreciated that the signal processing logic 24 can be implemented as dedicated hardware, machine executable instructions stored on a non-transitory computer readable medium and executed by an associated processor, or a mixture of software instructions and dedicated hardware. The extracted information is then provided to the automobile 12 via a transceiver (Tx) 26. It will be appreciated that the transceiver 26 can be implemented to take advantage of existing V2X protocols, such that communication with existing infrastructure and vehicle systems can be easily achieved.

In another implementation, the detector assembly 22 includes a camera, radar assembly, Lidar assembly, or other imaging apparatus that can capture images or video of a roadway around the automobile, and the signal processing logic 24 includes pattern recognition software that identifies objects or conditions within the images. For example, the images can be reviewed for dense fog or snow squalls that might negatively affect visibility, and a driver can be warned. Alternatively, any of pedestrians, other vehicles, lane markings, and animals can be identified in the images and associated with a real-world position based on a known position of the UAV 20, an angle of the camera, and the position of the object within the image. Accordingly, collision detection systems at the automobile 12 can be updated with the positions of any identified objects.

In still another implementation, the detector assembly 22 can include an antenna that receives signals from a remote device (not shown), and the signal processing logic 24 includes a receiver that conditions and demodulates signals received at the antenna. It will be appreciated that, in this implementation, the antenna and one or more components of the receiver can be shared with the transceiver 26. In one example, the remote device can be a satellite in a global navigation satellite system (GNSS) constellation, and GNSS data extracted from the signal and a position of the UAV can be provided to the automobile 12, for example, to allow for a more accurate position of the vehicle to be determined via differential GNSS techniques. In this example, the UAV 20 can be constrained to a specific location to provide a known location for differential GNSS. For example, the UAV 20 can be physically tethered to an object having a known location.

In another example, the remote device can be a component of a vehicle-to-external system, and the received signal can contain information representing traffic conditions gathered at that component or another component of the vehicle-to-external system, such as existing infrastructure, another UAV, a different vehicle, or a mobile device associated with a pedestrian. In this instance, the UAV 20 may be one of a number of UAVs assigned to a given region to provide a comprehensive sensor and communications network for that region, with relevant data from across that region provided to the automobile 12. The UAV 20 can be assigned to a specific position or route of travel as part of a vehicle-to-infrastructure communication system. In one implementation, the resulting sensor and communications network can be used to provide an overall map contained in a data structure (e.g., an evidence grid) of vehicle positions and trajectories, roadways, and other features, and transmit the map to appropriately equipped vehicles within the region. It will be appreciated that the UAVs can be provided to supplement existing infrastructure, and that the UAV 20 can work in concert with one or both of existing infrastructure components and any other UAVs to provide coverage for a given region. The UAV 20 can be programmed to return to a base station for recharging and/or refueling, with another UAV from a fleet of UAVs replacing the UAV during this time.

Alternatively, the UAV 20 can be assigned to the automobile 12 to extend the sensing and communication capabilities of the automobile. In such a case, the UAV 20 can include a navigation system, such as a GNSS system, that determines a position of the UAV relative to the vehicle and a propulsion system that allows the UAV to maintain the desired position. The automobile 12 can include a recharging station, for example, on a roof of the automobile, with the UAV 20 periodically returning to the automobile 12 to recharge.

To prevent unauthorized access to or spoofing of data exchanged between the UAV 20 and the vehicle, the UAV can also include a processor and a non-transitory computer readable medium storing machine executable instructions for authenticating, encrypting, and decrypting messages at the transceiver 26. Accordingly, the machine executable instructions can include an encryption module that receives information representing traffic conditions from the signal processing logic and encrypts the information for transmission at the transceiver and/or produces a signature or message authentication code (MAC), as well as a decryption module that receives communications from the automobile from the transceiver and decrypts the information for transmission at the transceiver and/or checks the signature or MAC. Where the UAV 20 is part of a vehicle-to-external system, communications between the UAV and other components of the vehicle-to-external system can also be protected via these encryption and authentication protocols.

Other methods for protecting data can include intrusion detection algorithms at the UAV 20, structuring the memory at the UAVs such that only certain data structures can be updated, logging all communication, and geofencing the drones to a desired region. Accordingly, the ability of the UAV to surveil any locations other than those associated with the monitored traffic conditions can be limited, as can access to the data outside of the communication system. Effectively, any stored data can be encrypted at the device, with access to the data limited to system administrators. Vulnerability surveillance of the UAV can be conducted periodically to identify and ameliorate any vulnerabilities in the software.

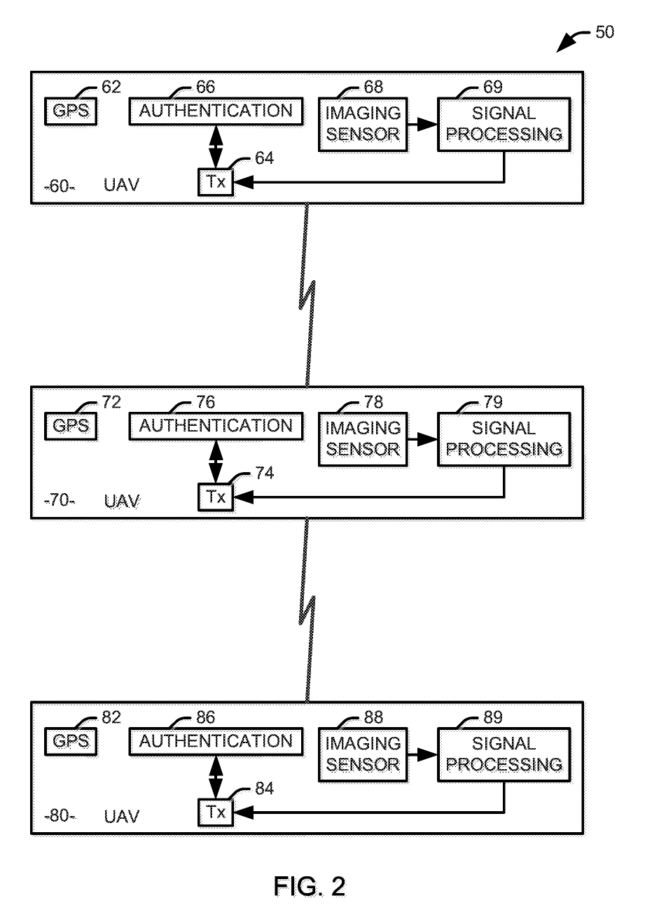

FIG. 2 illustrates one example of a portable infrastructure system 50 using a plurality of drones in a vehicle-to-external environment. In the illustrated system 50, a plurality of drones 60, 70, and 80 are deployed at desired locations within a region of interest to provide or augment infrastructure within the region. Each drone 60, 70, and 80 can be maintained at its desired location via one of a physical tether to an existing structure and a virtual tether to a geographic location. In the illustrated implementation, a virtual tether is used, and each drone 60, 70, and 80 includes a GPS system 62, 72, and 82 that reports the current location to the drone and allows the desired position to be maintained.

Each drone 60, 70, and 80 also includes a transceiver (Tx/Rx) 64, 74, and 84 for communicating with one another, other elements of the vehicle-to-external system, and vehicles within the region of interest. An authentication module 66, 76, and 86 associated with each transceiver 64, 74, 84 ensures that received communications are from authorized elements of the vehicle-to-external system and encodes communications transmitted at the transceiver for verification at the other elements. In one implementation, outgoing messages are encoded with a private encryption key for decoding with a public key stored at other elements. Alternatively, each message can contain a signature or message authentication code.

In the illustrated implementation, each drone 60, 70, and 80 includes an imaging sensor 68, 78, and 88 configured to capture images within the region of interest. In the illustrated implementation, the imaging sensor 68, 78, and 88 is a visible light camera, but it will be appreciated that the drone can include, alternatively or additionally, other imaging sensors, such as radar systems and infrared cameras. Given the substantially fixed location of each drone, it will be appreciated that the imaging sensors can be oriented to image specific regions, such as roadways and traffic signals. The captured images can then be processed at associated signal processing logic 69, 79, and 89 to extract relevant information from the images.

In one implementation, the signal processing logic 69, 79, and 89 can include an image segmentation component that extracts one or more regions of interest from the images. In one example, the fixed location of the drone can be exploited to define various subregions of interest in the captured image, such as roadways, traffic signals, and representative regions of the sky for weather monitoring. These subregions can then be examined for candidate objects of interest, for example, using a template-matching algorithm. To this end, a windowing algorithm can be used to locate and segment regions of contiguous locations within the subregions, and each of these subregions can then be compared to each a plurality of templates to provide a fitness metric, representing objects of interest, such as vehicles, pedestrians, common road obstructions, and traffic signals. To facilitate this analysis, the fixed position of the drone can be exploited to allow each template to be scaled to a size suitable for the position of the candidate object within the image. When the fitness metric exceeds a threshold value, the object can be provided to a pattern recognition system for further analysis. In another implementation, an edge detection algorithm, for example, Canny edge detection, can be applied to the image in place of the windowing algorithm to detect candidates for classification. In such a case, the templates are applied to the outlines created by the detected edges.

A pattern recognition classifier can utilize one or more pattern recognition algorithms, each of which analyze extracted features to identify an object or condition of interest within the image. Where multiple classification algorithms are used, an arbitration element can be utilized to provide a coherent result from the plurality of classifiers. Each classifier is trained on a plurality of training images representing the classes of interest. The training process of the a given classifier will vary with its implementation, but the training generally involves a statistical aggregation of training data from a plurality of training images into one or more parameters associated with the output class. Any of a variety of optimization techniques can be utilized for the classification algorithm, including support vector machines, self-organized maps, fuzzy logic systems, data fusion processes, ensemble methods, rule based systems, or artificial neural networks.

For example, a support vector machine (SVM) classifier can process the training data to produce functions representing boundaries in a feature space defined by the various features. Similarly, an artificial neural network (ANN) classifier can process the training data to determine a set of interconnection weights corresponding to the interconnections between nodes in its associated the neural network.

A SVM classifier can utilize a plurality of functions, referred to as hyperplanes, to conceptually divide boundaries in the N-dimensional feature space, where each of the N dimensions represents one associated feature of the feature vector. The boundaries define a range of feature values associated with each class. Accordingly, an output class and an associated confidence value can be determined for a given input feature vector according to its position in feature space relative to the boundaries. A rule-based classifier applies a set of logical rules to the extracted features to select an output class. Generally, the rules are applied in order, with the logical result at each step influencing the analysis at later steps. A regression model can be configured to calculate a parameter representing a likelihood that the region of interest contains an object or condition of interest based on a set of predetermined weights applied to the elements of the feature vector.

An ANN classifier comprises a plurality of nodes having a plurality of interconnections. The values from the feature vector are provided to a plurality of input nodes. The input nodes each provide these input values to layers of one or more intermediate nodes. A given intermediate node receives one or more output values from previous nodes. The received values are weighted according to a series of weights established during the training of the classifier. An intermediate node translates its received values into a single output according to a transfer function at the node. For example, the intermediate node can sum the received values and subject the sum to a binary step function. A final layer of nodes provides the confidence values for the output classes of the ANN, with each node having an associated value representing a confidence for one of the associated output classes of the classifier. In a binary classification, for example, in determining if an object or condition of interest is or is not present in the region of interest, the final layer of nodes can include only a single node, which can be translated to a confidence value that an object or condition of interest is present.

The results of the classification can be provided to other elements of the vehicle to external system as well as to any vehicles within a predetermined distance of a given drone 60, 70, and 80 via the transceiver 64, 74, and 84. This information can be used to guide decision making, for example, in vehicle safety systems, at each vehicle.

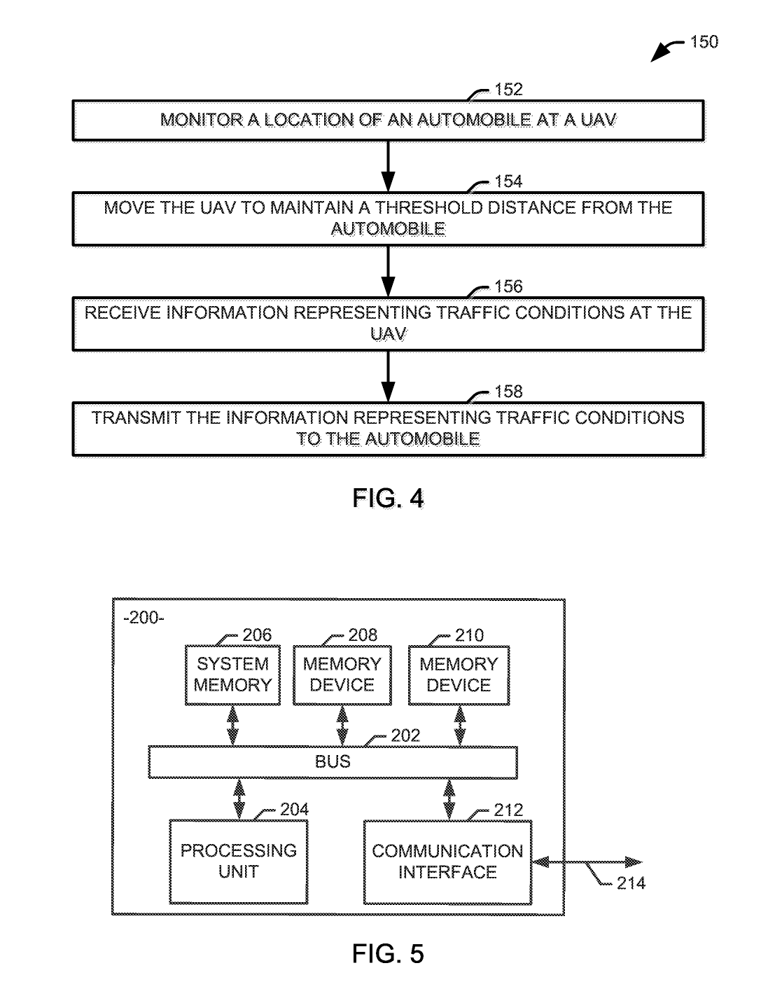

In view of the foregoing structural and functional features described above in FIGS. 1 and 2, example methods will be better appreciated with reference to FIGS. 3 and 4. While, for purposes of simplicity of explanation, the methods of FIGS. 3 and 4 are shown and described as executing serially, it is to be understood and appreciated that the present invention is not limited by the illustrated order, as some actions could in other examples occur in different orders and/or concurrently from that shown and described herein.

FIG. 3 illustrates one method 100 for providing vehicle-to-external services to an automobile. At 102, a band of electromagnetic radiation is monitored at an unmanned air vehicle (UAV). For example, the band can be a specific radio frequency (RF) band for receiving communications or imaging with a radar system, all or a portion of the visible light spectrum, all or a portion of the infrared spectrum, or a specific frequency within the infrared or visible spectrum for Lidar applications. At 104, the monitored electromagnetic radiation is converted into an electronic signal at a detector assembly on the UAV. This can include reducing RF signals to electronic signals at an antenna or antenna array or capturing an image at a visible light camera, an infrared camera, a radar assembly, or other imaging apparatus.

At 106, information representing traffic conditions is extracted from the electronic signal at signal processing logic. For example, the signal processing logic can include a receiver that extracts messages containing the information representing traffic conditions from at least one component of a vehicle-to-external network associated with the UAV. Alternatively, the electronic signal can represent images including a region in front of the vehicle, and signal processing logic can analyzing at least one captured image to extract the information representing traffic. At 108, the information representing traffic conditions is communicated to the automobile at a transceiver associated with the UAV.

FIG. 4 illustrates another method 150 for providing vehicle-to-external services to an automobile. At 152, a location of the automobile is monitored at an unmanned air vehicle (UAV). At 154, the UAV is moved as to remain within a threshold distance of the monitored location. For example, a location of the UAV can be monitored at a GPS and a location of the vehicle can be reported via a transceiver, such that a relative location of the UAV and the vehicle can be continuously determined. Alternatively, the automobile can be tracked visually at an imaging sensor. To facilitate this tracking, a pattern, reflective in one of the visible and infrared spectra, can be added to a top or rear to the vehicle. This pattern can be detected at the sensor and used to determine a position of the automobile relative to the UAV.

At 156, information representing traffic conditions is received at the UAV. In one implementation, this can include receiving a message from another element of a vehicle-to-external system that includes the UAV, such as another UAV, a mobile device, or another automobile. In another implementation, receiving the information can include capturing images including a region in front of the vehicle at an imaging sensor and analyzing at least one captured image to extract the information representing traffic conditions. At 158, the received information representing traffic conditions is transmitted to the automobile via a transceiver associated with the UAV.

FIG. 5 is a schematic block diagram illustrating an exemplary system 200 of hardware components capable of implementing examples of the systems and methods disclosed in FIGS. 1-4. The system 200 can include various systems and subsystems implemented on a UAV, including a system bus 202, a processing unit 204, a system memory 206, memory devices 208 and 210, a communication interface 212 (e.g., a network interface), and a communication link 214. The system bus 202 can be in communication with the processing unit 204 and the system memory 206. The additional memory devices 208 and 210, such as a hard disk drive, server, standalone database, or other non-volatile memory, can also be in communication with the system bus 202. The system bus 202 interconnects the processing unit 204, the memory devices 206-210, and the communication interface 212. In some examples, the system bus 202 also interconnects an additional port (not shown), such as a universal serial bus (USB) port.

The processing unit 204 can be a computing device and can include an application-specific integrated circuit (ASIC). The processing unit 204 executes a set of instructions to implement the operations of examples disclosed herein. The processing unit can include one or more processing cores, each potentially capable of processing more than one data stream (e.g., as in GPUs).

The additional memory devices 206, 208, and 210 can store data, programs, instructions, database queries in text or compiled form, and any other information that can be needed to operate a computer. The memories 206, 208 and 210 can be implemented as computer-readable media (integrated or removable) such as a memory card, disk drive, compact disk (CD), or server accessible over a network. In certain examples, the memories 206, 208 and 210 can comprise text, images, video, and/or audio, portions of which can be available in formats comprehensible to human beings.

Additionally or alternatively, the system 200 can access an external data source or query source through the communication interface 212, which can communicate with the system bus 202 and the communication link 214.

In operation, the system 200 can be used to implement one or more parts of a communications system in accordance with the present invention. Computer executable logic for implementing the monitoring system resides on one or more of the system memory 206, and the memory devices 208, 210 in accordance with certain examples. The processing unit 204 executes one or more computer executable instructions originating from the system memory 206 and the memory devices 208 and 210. The term “computer readable medium” as used herein refers to a medium that participates in providing instructions to the processing unit 204 for execution, and can, in practice, refer to multiple, operatively connected apparatuses for storing machine executable instructions.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the scope of the appended claims.

What is claimed is:

1. A communications system comprising:
an unmanned air vehicle (UAV) comprising:
a detector assembly that converts electromagnetic radiation into an electronic signal;
signal processing logic that extracts information representing traffic conditions from the electronic signal; and
a transceiver that communicates with an automobile, such that the extracted information is provided to the automobile.

2. The communications system of claim 1, wherein the detector assembly is an antenna that receives messages containing the information representing traffic conditions from at least one component of a vehicle-to-external network and the signal processing logic is a receiver associated with the antenna.

3. The communications system of claim 2, wherein the transceiver and the receiver share at least one common component.

4. The communications system of claim 1, wherein the detector assembly is an imaging system, and the signal processing logic that analyzes at least one image from the imaging system to extract the information representing traffic conditions from the image.

5. The communications system of claim 4, wherein the imaging system comprises one of a camera and a radar assembly.

6. The communications system of claim 1, wherein the UAV comprises:
a navigation system that determines a position of the UAV; and
a propulsion system that maneuvers the UAV such that the UAV remains in a desired position.

7. The communication system of claim 6, wherein the navigation system that determines a position of the UAV relative to the automobile, such that the propulsion system maneuvers the UAV to remain in a desired position relative to the vehicle.

8. The communications system of claim 1, wherein the UAV is physically tethered to an object at a desired location.

9. The communications system of claim 8, wherein the UAV is a first UAV and the desired location is a first location, the system further comprising a second UAV, physically tethered to an object at a second location.

10. The communications system of claim 1, the UAV further comprising:
a processor; and
a non-transitory computer readable medium storing machine executable instructions, the machine executable instructions comprising an encryption module that receives information representing traffic conditions from the signal processing logic and encrypts the information for transmission at the transceiver.

11. The communications system of claim 10, the machine executable instructions further comprising a decryption module that receives communications from the automobile from the transceiver and decrypts the information for transmission at the transceiver.

12. A method for providing vehicle-to-external services to an automobile, comprising:
monitoring a band of electromagnetic radiation at an unmanned air vehicle (UAV);
converting the monitored electromagnetic radiation into an electronic signal at a detector assembly on the UAV;
extracting information representing traffic conditions from the electronic signal at signal processing logic; and
communicating the information representing traffic conditions to the automobile.

13. The method of claim 12, wherein the detector assembly is an antenna, and monitoring a band of electromagnetic radiation at the UAV comprises receiving messages containing the information representing traffic conditions from at least one component of a vehicle-to-external network associated with the UAV.

14. The method of claim 12, wherein the detector assembly is an imaging system, and monitoring a band of electromagnetic radiation at the UAV comprises capturing images including a region in front of the vehicle, and extracting information representing traffic conditions from the electronic signal comprises analyzing at least one captured image to extract the information representing traffic.

15. The method of claim 14, wherein the imaging system comprises one of a visible light camera, an infrared camera, and a radar assembly.

16. A method for providing vehicle-to-external services to an automobile, comprising:
monitoring a location of the automobile at a unmanned air vehicle (UAV);
moving the UAV as to remain within a threshold distance of the monitored location;
receiving information representing traffic conditions at the UAV; and
transmitting the received information representing traffic conditions to the automobile via a transceiver associated with the UAV.

17. The method of claim 17, wherein receiving information representing traffic conditions at the UAV comprises receiving a message from another element of a vehicle-to-external system that includes the UAV.

18. The method of claim 16, wherein the automobile is a first automobile and receiving information representing traffic conditions at the UAV comprises receiving a message from a second automobile.

19. The method of claim 16, wherein receiving information representing traffic conditions at the UAV comprises capturing images including a region in front of the vehicle, and analyzing at least one captured image to extract the information representing traffic conditions.

20. The method of claim 16, further comprising monitoring a location of the UAV at a global position system (GPS) associated with the UAV.
